(19) United States
(12) Patent Application Publication
(10) Pub. No.: US 2022/0335685 A1
(43) Pub. Date: Oct. 20, 2022

(54) METHOD AND APPARATUS FOR POINT CLOUD COMPLETION, NETWORK TRAINING METHOD AND APPARATUS, DEVICE, AND STORAGE MEDIUM

(71) Applicant: SENSETIME INTERNATIONAL PTE. LTD., Singapore (SG)

(72) Inventors: Zhongang CAI, Singapore (SG); Xinyi CHEN, Singapore (SG); Junzhe ZHANG, Singapore (SG); Haiyu ZHAO, Singapore (SG); Shuai YI, Singapore (SG)

(21) Appl. No.: 17/363,139

(22) Filed: Jun. 30, 2021

Related U.S. Application Data
(63) Continuation of application No. PCT/IB2021/054966, filed on Jun. 7, 2021.

(30) Foreign Application Priority Data
Apr. 15, 2021 (SG) 10202103895P

(51) Int. Cl. G06T 17/00; G06T 9/00

(52) U.S. Cl. CPC G06T 17/00; G06T 9/00

(57) ABSTRACT

Embodiments of the present disclosure provide a method and apparatus for point cloud completion, a network training method and apparatus, a device, and a storage medium. The method includes: determining a probability distribution of an acquired first point cloud; completing the first point cloud based on the probability distribution to obtain a primary completed point cloud; concatenating the primary completed point cloud and the first point cloud to obtain a concatenated point cloud; determining association relationships between the concatenated point cloud and multiple groups of neighbouring points of the concatenated point cloud; completing the concatenated point cloud based on the association relationships to obtain a second point cloud from completion the first point cloud.

### CROSS-REFERENCE TO RELATED APPLICATIONS

This is a continuation application of International Patent Application No. PCT/IB2021/054966, filed on Jun. 7, 2021, and claiming priority to Singaporean Patent Application No. 10202103895P, filed on Apr. 15, 2021. The contents of International Patent Application No. PCT/IB2021/054966 and Singaporean Patent Application No. 10202103895P are incorporated herein by reference in their entireties.

### TECHNICAL FIELD

Embodiments of the present disclosure relate to the technical field of cloud data processing, and relate to, but are not limited to, a method and apparatus for point cloud completion, a network training method and apparatus, a device, and a storage medium.

### BACKGROUND

In related art, compared with pictures or videos, a data format of a point cloud does not lose information of a distance between an object and a sensor, that is, 3D position information of an object in space can be obtained. Moreover, the ambiguity (for example, a position of a human body in 3D space is unclear) caused by pictures or videos can be avoided using point clouds. However, a point cloud outputted in a point cloud generation task cannot retain the details in an input incomplete point cloud, thus a global shape cannot be completed based on the incomplete details, and the generated point cloud has an incomplete shape accordingly.

### SUMMARY

Embodiments of the disclosure provide a technical solution for point cloud completion.

An embodiment of the present disclosure provides a method for point cloud completion, including: determining a probability distribution of an acquired first point cloud; completing the first point cloud based on the probability distribution to obtain a primary completed point cloud; concatenating the primary completed point cloud and the first point cloud to obtain a concatenated point cloud; determining association relationships between the concatenated point cloud and multiple groups of neighboring points of the concatenated point cloud; and completing the concatenated point cloud based on the association relationships to obtain a second point cloud from completion to the first point cloud.

An embodiment of the present disclosure provides a method for training a point cloud completion network, including: acquiring a first sample point cloud; determining a sample probability distribution of the first sample point cloud using a preset probability generation network; predicting a complete shape of the first sample point cloud based on the sample probability distribution to obtain a first predicted point cloud; adjusting the first predicted point cloud based on the first sample point cloud by using a preset relationship enhancement network to obtain a second predicted point cloud; adjusting a network parameter of the probability generation network based on loss of the first predicted point cloud, and adjusting a network parameter of the relationship enhancement network based on loss of the second predicted point cloud; and generating a point cloud completion network based on the probability generation network with the adjusted parameter and the relationship enhancement network with the adjusted parameter. In this way, the training process of the point cloud completion network is implemented by the two networks, and a point cloud with reasonably high precision can be generated while preserving details of the input incomplete point cloud on the basis of the input incomplete point cloud.

An embodiment of the present disclosure provides an apparatus for point cloud completion to implement a method in any one of the above embodiments.

### BRIEF DESCRIPTION OF THE DRAWINGS

FIG. 1 is a schematic diagram of an implementation flow of a method for point cloud completion according to an embodiment of the present disclosure;

FIG. 2A is a schematic diagram of another implementation flow of a method for point cloud completion according to an embodiment of the present disclosure;

FIG. 2B is a schematic diagram of an implementation flow of a method for training a point cloud completion network according to an embodiment of the present disclosure;

FIG. 3A is a schematic diagram of structure and composition of an apparatus for point cloud completion according to an embodiment of the present disclosure;

FIG. 3B is a schematic diagram of structure and composition of an apparatus for training a point cloud completion network according to an embodiment of the present disclosure; and

FIG. 4 is a schematic diagram of structure and composition of a computer device according to an embodiment of the present disclosure.

### DETAILED DESCRIPTION

To make the purpose, technical solution, and advantages of the embodiments of the present disclosure more apparent, specific technical solutions of the present disclosure will be described in further detail below in conjunction with the accompanying drawings. The following embodiments serve to illustrate the present disclosure, but are not intended to limit the scope of the present disclosure.

In the following description, reference is made to “some embodiments” which describe a subset of all possible embodiments; but it is to be understood that “some embodiments” may be a same subset or different subsets of all possible embodiments, and may be combined to each other in the absence of conflict.

In the following description, the reference to the term “first\second\third” is to merely distinguish between similar objects and does not represent a specific order for the objects, it being understood that, if allowed, the certain order or sequence indicated by “first \second\third” may be exchanged, such that the embodiments of the present disclosure described herein can be implemented in an order other than the order given in the drawings and the description.

Unless defined otherwise, all technical and scientific terms used herein have the same meaning as commonly understood by those skilled in the art to which this disclosure belongs. The terms used herein is for the purpose of describing embodiments of the present disclosure only and is not intended to limit the present disclosure.

The wording and terms referred to in the embodiments of the present disclosure are applicable to the following explanations.

Global average pooling, also referred to as undersampling or down-sampling, is mainly used to implement feature dimension reduction, compress the quantity of data and the quantity of parameters, reduce overfitting, and improve the fault tolerance of a model.

Full connected layer is used to integrate features which are highly abstracted after multiple times of convolution, then normalize the features, output respective probabilities for classified cases, allowing a following classifier to perform classification based on the probabilities obtained from full connection.

Variational automatic encoder is an important generation model. It is assumed that observable data is x, x being generated from a hidden variable z. The process z→x refers to a generation model p_{θ}(x|z), which is a decoder from the perspective of autoencoder; instead, the process x→z refers to an identification model q_{ϕ}(z|x), which is an encoder similar to the autoencoder.

An exemplary application of the apparatus for point cloud completion is described below. The apparatus provided in the embodiments of the present disclosure may be implemented as various types of user terminals such as a notebook computer, a tablet computer, a desktop computer, a camera, a mobile device (e.g., a personal digital assistant, a dedicated messaging device, a portable game device), and may also be implemented as a server. Next, an exemplary application in which the apparatus is implemented as a terminal or a server will be described.

The method may be applied to a computer device, the functions implemented by the method may be implemented by a processor in the computer device calling program codes which may be stored in a computer storage medium. It can be seen that the computer device includes at least a processor and a storage medium.

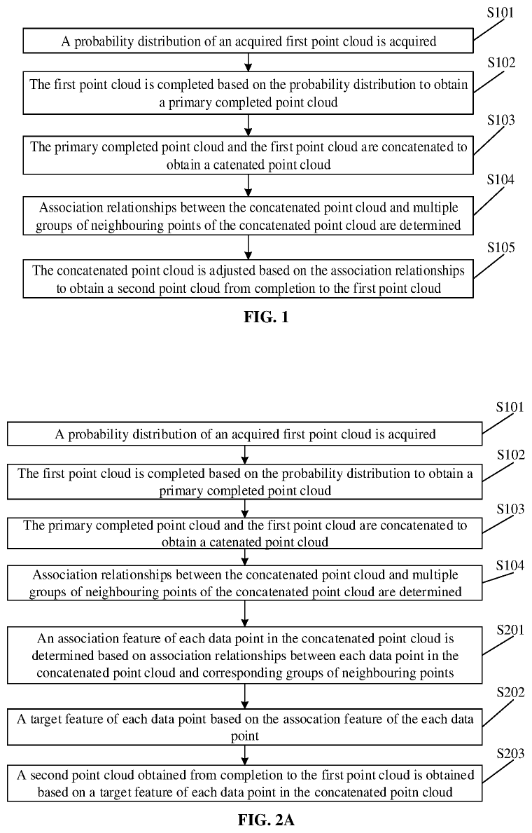

An embodiment of the present disclosure provides a method for point cloud completion, as shown in FIG. 1A.

In operation S101, a probability distribution of an acquired first point cloud is determined.

The acquired first point cloud may be acquired 3-Dimension (3D) point cloud data, or received 3D point cloud data transmitted by other devices. For example, the 3D point cloud data may be point cloud data acquired at an angle for a desk lamp and representing the appearance of the desk lamp, or the 3D point cloud data may be received point cloud data transmitted by any device and representing an object. The first point cloud may be a complete point cloud capable of relatively completely representing the shape of the object, or may be an incomplete point cloud capable of representing a portion of the shape of the object. The probability distribution of the first point cloud is a conditional probability distribution obtained from the encoding on the first point cloud.

The probability distribution of the first point cloud may be determined using a point cloud completion network. The point cloud completion network may include two parts: a probability generation network for generating a primary completed point cloud and a relationship enhancement network for generating a high-quality output point cloud based on the primary completed point cloud. The resulting completed point cloud largely retains the details of the input point cloud. By encoding the first point cloud by using the variational automatic encoder of the probability generation network and processing the encoded point cloud with a linear residual module, the conditional probability distribution of the first point cloud can be quickly determined, that is, the above-mentioned operation S101 may be realized as follows.

In operation S111, variational encoding is performed on the first point cloud to obtain an encoded point cloud.

Variational encoding may be performed on the first point cloud by using a variational automatic encoder 521 as shown in FIG. 5. The implementation process is as follows.

First, a feature dimension of an input first point cloud is converted to 128 by using a first shared Multi-Layer Perceptron (MLP) network; next, the point cloud feature with a feature dimension being 128 is converted into a point cloud feature with a dimension being 256 by using a second shared multi-layer perceptron network; then, the point cloud feature with a dimension being 256 is input to a pooling layer for maximum pooling processing; then, element-by-element multiplication is performed between the pooling processing result and the point cloud feature with a dimension being 256; then, the multiplication result is input to a third shared multi-layer perceptron network to convert the point cloud feature with a feature dimension being 256 into a point cloud feature with a dimension being 512; then, the point cloud feature with a feature dimension being 512 is converted into a point cloud feature with a dimension being 1024 by using a fourth shared multi-layer perceptron network; finally, the point cloud feature with a dimension being 1024 is input to the pooling layer for maximum pooling processing to obtain the encoded point cloud.

In operation S112, residual processing is performed on the encoded point cloud to obtain a residual point cloud.

The residual point cloud may be obtained by performing linear residual processing on the encoded point cloud using a plurality of linear residual modules in the probability generation network. As shown in FIG. 5, a plurality of linear residual modules 522 are used to perform residual processing on the pooling result, thereby obtaining the residual point cloud. For example, the first point cloud input to the variational automatic encoder has a dimension of 3*1024 and the output has 1024 values which are values of the residual point cloud.

In operation S113, the probability distribution is determined based on the residual point cloud.

The conditional probability distribution of the first point cloud may be obtained by sampling and plotting points in the incomplete point cloud. That is, the conditional probability distribution of the first point cloud may be obtained from the 1024 values output by the variational automatic encoder. The conditional probability distribution 523 in FIG. 5 is close to the Gaussian distribution. Thus, a conditional probability distribution of the first point cloud can be accurately determined by performing variational encoding on the first point cloud in a manner of the variational automatic encoding in the point cloud completion network, and by performing residual processing on the encoded point cloud through the plurality of linear residual modules in the point cloud completion network.

In operation S102, the first point cloud is completed based on the probability distribution to obtain a primary completed point cloud.

In a point cloud completion network, a complete shape of an object to which the first point cloud belongs may be predicted by reference to a difference between the probability distribution of the first point cloud and a standard normal distribution; and the first point cloud may be completed by a difference value between the point cloud data of the complete shape and the first point cloud, so that a roughly estimated primary completed point cloud can be obtained. The primary completed point cloud is used to roughly describe the general contour of the object to which the first point cloud belongs.

In the probability generation network of the point cloud completion network, the rough complete shape of the first point cloud may be predicted by the difference between the standard normal distribution and the probability distribution of the first point cloud, that is, the operation S102 may be implemented as follows.

In operation S121, an appearance shape of an object to which the first point cloud belongs is predicted based on the probability distribution.

The appearance shape of the object to which the first point cloud belongs to may be the appearance shape of the object at a viewing angle corresponding to the first point cloud. For example, the viewing angle of the object to which the first point cloud belongs may be first determined, and the appearance shape of the object at the viewing angle may be predicted by combining the viewing angle and the difference value. The complete appearance of the object to which the first point cloud belongs may be predicted based on the difference value between the probability distribution of the first point cloud and the standard normal distribution. When the first point cloud is point cloud data, i.e., a global feature of an incomplete point cloud, of a desk lamp acquired at a certain angle, a complete appearance shape of the object to which the first point cloud belongs may be predicted based on a difference value between a probability distribution of the first point cloud and a standard normal distribution. The global feature may be completed by the appearance shape, thereby obtaining a primary completed point cloud describing the overall framework of the desk lamp.

In operation S122, a second appearance shape of the object represented by the first point cloud is determined.

The integrity of the first appearance shape may be greater than the integrity of the second appearance shape. An appearance shape, i.e., a second appearance shape, of the object represented by the first point cloud may be determined based on the distribution of the first point cloud. When the first point cloud is an incomplete point cloud, the second appearance shape is a partial appearance shape of the object.

In operation S123, the second appearance shape is completed based on the first appearance shape to obtain the primary completed point cloud.

After the appearance contour, i.e., the first appearance shape, of the object to which the first point cloud belongs at the viewing angle of the first point cloud is predicted, the difference between the first appearance shape and the second appearance shape may be determined. Based on this, the second appearance shape may be completed to obtain a completed appearance shape. Based on the completed appearance shape, the primary completed point cloud can be obtained. Thus, by predicting the appearance shape of the object to which the first point cloud belongs and completing the appearance shape of the first point cloud, the details of the input first point cloud can be better retained and completed on the basis of the details of the input first point cloud.

In operation S103, the primary completed point cloud and the first point cloud are concatenated to obtain a concatenated point cloud.

The estimated rough contour of the first point cloud, i.e., the primary completed point cloud, and the first point cloud may be concatenated to obtain the concatenated point cloud.

The above-mentioned operations S101 to S103 may be implemented using a probability generation network of a point cloud completion network. In the process of training the probability generation network, the distribution and feature of the incomplete point cloud and the distribution and feature of the complete point cloud corresponding to the incomplete point cloud can be learned, so that the probability generation network can be applied to generate a rough point cloud which conforms to the shape of the incomplete point cloud and has a reasonable contour. That is, the probability generation network may be adopted to generate a primary completed point cloud with a reasonable contour corresponding to a to-be-completed network. After the operation S103, the primary completed point cloud output from the probability generation network may be combined with the first point cloud, which are then input into a relationship enhancement network of the point cloud completion network, that is, operation S104 is performed.

In the operation S104, association relationships between the concatenated point cloud and multiple groups of neighbouring points of the concatenated point cloud are determined.

In the relationship enhancement network, for each data point in the concatenated point cloud, multiple groups of neighbouring points corresponding to the data point may be determined first. Different groups of neighbouring points have a different scale. The scale of each group of neighbouring points represents the number of neighbouring points in this group. In other words, different groups of neighbouring points have a different number of neighbouring points. For example, when the number of neighbouring points in a group of neighbouring points of a data point is K1 and the number of neighbouring points in another group of neighbouring points is K2, the scales of the two multiple groups of neighbouring points are determined to be K1 and K2, respectively. Then, an association relationship between each group of neighbouring points and a data point is determined. The association relationship represents interaction between each neighbouring point in the group of neighbouring points and the data point. The association relationship may be represented by interaction parameters and weight coefficients between the neighbouring points and the data point. The association relationship may include a position relationship; and/or the association relationship may represent a potential association between a physical object represented by each of neighbouring points in a group of neighbouring points and a physical object represented by a corresponding data point of data of the concatenated point cloud, respectively, for example, the association relationship indicates whether the two points are points representing the same physical object, or includes at least one of followings: a positional relationship, a category similarity, a dependency relationship or the like in a case where the two points represent different physical objects. The above-mentioned association relationship may be represented by weight coefficients and association parameters between neighbouring points and a corresponding data point in the concatenated point cloud to which the neighbouring points belong. For each of the multiple groups of neighbouring points, an association parameter between each of the group of neighbouring points and the corresponding data point may be analyzed. Based on the association parameters, the association relationship between the group of neighbouring points and the corresponding data point can be overally determined, thereby obtaining the association relationship between each group of neighbouring points and the corresponding data point. In this way, by determining the association relationships between each data point and corresponding groups of neighbouring points, the association relationships between the entire concatenated point cloud and the multiple groups of neighbouring points of the concatenated point cloud can be obtained. In this way, the point cloud selective module may be used to learn the structural relationship of the multiple groups of neighbouring points of different scales of the point cloud, so as to improve the accuracy of the point cloud completion.

In operation S105, the concatenated point cloud is adjusted based on the association relationship to obtain a second point cloud obtained from completion to the first point cloud.

For each data point in the concatenated point cloud, the point cloud feature of the primary completed point cloud may be enhanced according to an association relationship between a group of neighbouring points and corresponding data points, to obtain a finer point cloud feature; and the primary point cloud may be completed by the finer point cloud feature to obtain a second point cloud of the first point cloud.

By considering the probability distribution of the first point cloud, a reasonable contour of the first point cloud can be predicted, thereby obtaining a primary completed point cloud that conforms to the shape of the first point cloud and is reasonable. Moreover, by combining the structural relationship of multiple groups of neighbouring points of different scales of the concatenated point cloud, the accuracy of the primary completed point cloud can be improved, so that the second point cloud with high-precision point cloud details can be obtained.

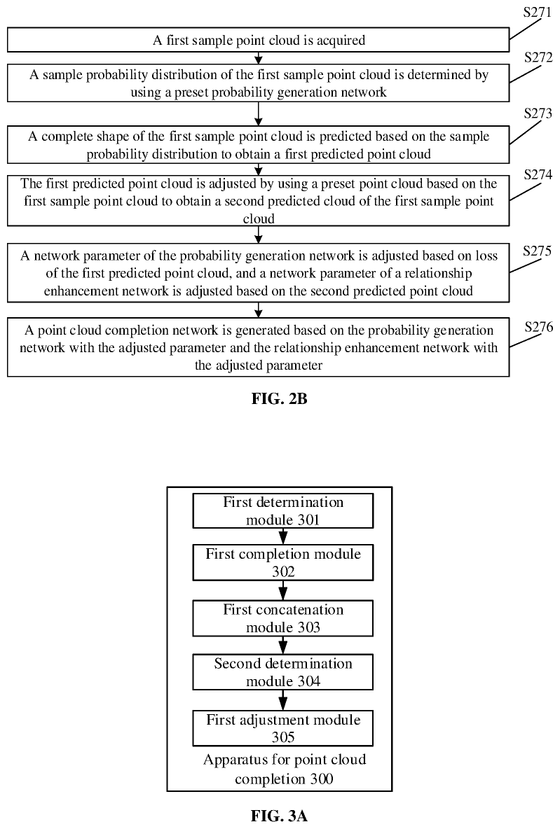

In the relationship enhancement network of the point cloud completion network, the target feature of each data point in the concatenated point cloud maybe determined by fusing the association feature of the each data point of multiple groups of neighbouring points of different scales, thereby obtaining a second point cloud that can contain fine point cloud details. That is, the above-mentioned operation S105 may be realized by the operations shown in FIG. 2A, and the following description is made in connection with FIGS. 1 and 2A.

In operation S201, an association feature of each data point in the concatenated point cloud is determined based on association relationships between the each data point in the concatenated point cloud and corresponding groups of neighbouring points.

In the relationship enhancement network, for any one of the concatenated points in the concatenated point cloud, one, two or more groups of neighbouring points may be determined with the concatenated point as a center point; the number of neighbouring points in each group may be the same or different. The association relationship between each group of neighbouring points and the corresponding data point is used to represent an association degree between each neighbouring point in the group of neighbouring points and the corresponding data point. For each of the groups of neighbouring points, the association parameter between each of the group of neighbouring points and the corresponding data point is analyzed, and the association relationship between each group of neighbouring points and the corresponding data point may be overally determined, thereby obtaining the association relationships between each data point and the corresponding groups of neighbouring points. Based on this, the number of association features of each data point corresponds to the number of groups of neighbouring points, that is, a group of association features of the data point is obtained by interacting a group of neighbouring points with the corresponding data point, and the group of association features takes fully into account the feature information of the group of neighbouring points. Since one concatenated point has multiple groups of neighbouring points, there are multiple groups of association features. For each neighbouring point in a group of neighbouring points, interaction processing may be first performed on the feature of the neighbouring point and the feature of the corresponding data point based on an interaction parameter to obtain a set of interacted initial features; then, the interacted initial features may be fused for the multiple groups to obtain an association feature of the corresponding data point of each group. The association feature of the concatenated point take into account the association relationships between the initial feature of the neighbouring points of the group and the initial features of the neighbouring points of the surrounding groups, thereby making the association features of the obtained concatenated point more critical and richer.

In operation S202, a target feature of each data point is determined based on the association feature of the each data point.

The association feature of the concatenated point corresponding to each group of neighbouring points may be fused to obtain the target feature of each data point. Among the multiple groups of neighbouring points of each data point, an association feature corresponding to each group of neighbouring points may be obtained by adopting a Point cloud self-attention kernel module; thus, weighted summation may be made between the weights of association features of respective groups of neighbouring points and the respective groups of neighbouring points to obtain the target feature that takes into account features of multiple groups of neighbouring points. Thus, by adaptively selecting association relationships between neighbouring points of different scales and a corresponding data point, and determining the target feature of the concatenated point based on multiple groups of association features, the scale invariance in the point cloud learning can be solved, and the point cloud feature can be enhanced.

In operation S203, a second point cloud obtained from completion to the first point cloud is obtained based on a target feature of each data point in the concatenated point cloud.

The target feature of each data point in the concatenated point cloud may be fused into the primary completed point cloud, and the structural relationship between each data point and multiple groups of neighbouring points can be supplemented into the primary completed point cloud, so as to obtain a second point cloud representing a fine structure of the first point cloud. By fusing features of multiple groups of neighbouring points of different scales, features of point clouds of different scales can be considered, so that scale invariance of the features of the point cloud is realized, and the extracted features of the point cloud are further enriched.

Global average pooling processing may be performed on multiple groups of association features, and a group association degree of each group of neighbouring points among the association features may be determined, so that the target feature may be extracted by combining the group association degree with the association feature of the group, that is, the above-described operation S202 may be implemented as follows.

In operation S221, average pooling processing is performed on association features of each data point corresponding to the groups of neighbouring points to obtain a pooling feature.

In order to determine which group of neighbouring points is more important than each data point, the association features corresponding to the groups of neighbouring points may be first fused, and then a pooling layer is used to perform global average pooling on the importance degree of the fused features to obtain the pooling feature. The association features corresponding to the groups of neighbouring points may be first fused based on the pooling feature to obtain a fused feature set. For example, the association features corresponding to the groups of neighbouring points may be added element-by-element to obtain a fused feature. Then, average pooling processing may be performed on the fused features in the fusion feature set to obtain the pooling feature. For example, the fused features obtained by adding elements may be input to a global average pooling layer of the network and may be subjected to the global average pooling. Thus, the pooling feature that reduces the dimension of the fused feature can be obtained to improve the robustness of the network.

In operation S222, a group association degree between each group of neighbouring points and a corresponding data point is determined based on the pooling feature.

The pooling feature may be first input to a fully connected layer in a network architecture to classify a group of neighbouring points based on the importance degree of each of the group of neighbouring points to a corresponding data point, resulting in a set of neighbouring points marked with an importance degree. Then, two fully connected layers may be used to classify the neighbouring points belonging to the same group from the set of neighbouring points marked with an importance degree. Finally, based on the importance degree of the neighbouring points of the same group, the importance degree of the group to the corresponding data point, i.e., the group association degree of the group, may be determined.

In operation S223, a target feature of each data point is determined based on the group association degree and the association feature of the each data point.

Two vectors, i.e., a group association degree of a group and a corresponding association feature of the group, may be multiplied element-by-element, so that multiplication results of groups are obtained; then, the multiplication results of the plurality of groups may be added element-by-element to obtain a final target feature.

The association feature of each data point may be subjected to weighted adjustment based on the group association degree, and the adjusted association features may be fused to obtain the target feature of the data point, which is implemented as follows.

First, the association feature of each data point may be adjusted based on the group association degree of each group to obtain an adjusted association feature corresponding to each group of neighbouring points. For example, an association feature of the data point corresponding to each group may be weighted by the association degree of the group to obtain an adjusted association feature.

Then, the adjusted association features corresponding to the groups of neighbouring points of each data point may be fused to obtain the target feature of the each data point.

For example, after the adjusted association feature corresponding to each group of neighbouring points is obtained, the adjusted association features corresponding to the groups of neighbouring points may be added element-by-element to obtain the target feature of the data point. In this way, the association features of respective groups are weighted by the association degrees of the groups and then added up to obtain the target feature of the data point, so that the detailed information of the obtained target feature can be enriched.

Multiple groups of association features are fused and subjected to global average pooling processing, a pooling feature is input to a fully connected layer to determine, among the association features, an importance degree of each group of neighbouring points and combine the importance degree with the association feature corresponding to the group to obtain a final target feature. In this way, by combining the association degrees of multiple groups of neighbouring points of different scales with the association features of the multiple groups, a target feature of a point cloud with more detail can be extracted, so that a plurality of features of different scales can be selected and fused in the same layer, thereby enabling the trained network to adapt to the features of multiple scales in the process of training a point cloud completion network based on the features of the point cloud. The group association degree of a group may be determined by determining the association degree of each neighbouring point of the group of neighbouring points with the corresponding data point, that is, the above-described operation S222 may be implemented as follows.

In a first step, an association degree between each data point and each neighbouring point in the corresponding group of neighbouring points is determined based on the pooling feature, so as to obtain a set of point association degrees. In each group of neighbouring points, an importance degree of each neighbouring point to a data point corresponding to the neighbouring point may be determined, so that an association degree between the neighbouring point and the corresponding data point can be determined. For example, the confidence level of the feature of the neighbouring point being a key feature of the concatenated point may be used as the association degree between the neighbouring point and the corresponding data point. In a group of neighbouring points, the importance degree, i.e., the group association degree, of each neighbouring point in a group of neighbouring points to the corresponding data point may be analyzed by determining the confidence level of each neighbouring point being the key point of the concatenated point, and may be implemented as follows.

First, a first confidence level of the pooling feature being a key feature of a corresponding data point is determined. A key feature of a concatenated point is that a key point among proximate points of the concatenated point is in a linear relationship and an association relationship with the concatenated point. For example, the key point and the concatenated point have a closer semantic relationship and more interactions. In a specific example, the association features corresponding to the plurality of groups of neighbouring points may be fused. The pooling feature of the multiple groups of association features may be input into a fully connected layer, association features which are important features among the multiple groups of association features may be classified by using the fully connected layer, and the neighbouring points in the multiple groups of neighbouring points have association relationships with the association features, so as to make a classification based on whether each neighbouring point in the multiple groups of neighbouring points is a key point or not, and obtain a first confidence level of each neighbouring point being a key point of the concatenated point.

Next, based on the first confidence level, a second confidence level of the association feature corresponding to the same group of neighbouring points being the key feature is determined to obtain a set of second confidence levels. In order to determine which group of neighbouring points is more important to the concatenated point, multiple groups of association features, which have been fused together, may be distinguished by using a plurality of independent fully connected layers in a relationship enhancement network to obtain an importance degree, i.e., the second confidence level, of an association feature corresponding to each group of neighbouring points. Here, the number of independent fully connected layers is the same as the number of groups of neighbouring points, so that multiple groups of association features fused together can be distinguished from each other.

Finally, A group association degree of a group to which the neighbouring points of the same group belong is determined based on the set of second confidence levels.

A confidence level of an association feature corresponding to a group of neighbouring points being a key feature may be determined, and the confidence level is labeled for each association feature, to obtain the importance degree of the group. Thus, the importance degrees of multiple groups of association features fused together may be first classified by the fully connected layer, and then the plurality of groups of association features may be divided into independent groups by a plurality of independent fully connected layers, so that the importance degree of each group of neighbouring points can be determined.

In a second step, a group association degree of each group is determined based on the set of point association degrees.

A set of point association degrees of a group may be understood as a set of confidence levels for each neighbouring point in a group of neighbouring points being a key point of a concatenated point. the importance degree of the group to the corresponding data point, e.g., the group association degree of the group, may be obtained by adding up the confidence levels of a group of neighbouring points.

After point association degrees of a group of neighbouring points are obtained, the point association degrees of the group may be normalized to obtain a group association degree for each group. For example, this may be implemented as follows.

First, the second confidence levels in the set of second confidence levels are normalized to obtain a group normalization result. For example, in the relationship enhancement network, a group of second confidence levels corresponding to each group of neighbouring points may be input to the softmax layer of the network, and the point association degrees in the set of point association degrees may be processed by using a softmax function, so that a normalization result of each group can be obtained. Furthermore, the sum of the group normalization results of the multiple groups is equal to 1.

Then, the group association degree is determined based on the group normalization result. For example, a larger group normalization result indicates that a neighbouring point of a group is more important to a corresponding data point, that is, the probability that the neighbouring point of the group is a key point of the corresponding data point is greater. Thus, the importance degree of the entire group of neighbouring points may be determined by processing the point association degree of a group of neighbouring points using the softmax layer, so that the extracted point cloud feature can be enhanced according to the importance degree of the entire group of neighbouring points.

For each neighbouring point in each group of neighbouring points, the interaction between each neighbouring point and the corresponding data point may be realized in an adaptive manner, that is, the above-mentioned operation S104 may be implemented as follows.

In operation S141, a first initial feature of each group of neighbouring points and a second initial feature of each data point in the concatenated point cloud are determined respectively.

Feature extraction may be performed respectively for each neighbouring point in each group of neighbouring points to obtain a first initial feature, i.e., the first initial feature includes the initial feature of each neighbouring point; feature extraction may be performed on each data point to obtain a second initial feature. The feature extraction herein may be implemented by a trained multi-layer perceptron network or convolutional network or the like.

In operation S142, linear transformation is performed on the first initial feature based on a first preset value to obtain a first transformed feature.

The first preset value may be set to any value, e.g., the first preset value is set to 64, 32 or the like. First, a multi-layer perceptron network is used to perform linear processing on a first initial feature, for example, to perform dimension rise on the first initial feature; then linear transformation may be performed on the first initial feature after the dimension rise based on the first preset value to obtain the first transformed feature. For example, the dimension reduction may be performed on the first initial feature after the dimension rise based on the first preset value to obtain the first transformed feature.

In operation S143, linear transformation is performed on the second initial feature based on the first preset value to obtain a second transformed feature.

The processing on the second initial feature for each data point is similar to the processing on the first initial feature in operation S122 above. For example, a multi-layer perceptron network is first used to perform linear processing on the second initial feature, for example, to perform dimension rise on the second initial feature; then, linear transformation may be performed on the second initial feature after dimension rise based on the first preset value to obtain the second transformed feature. For example, the first preset value is used to reduce the dimension of the second initial feature after dimension rise to obtain the second transformed feature.

In operation S144, an interaction parameter between the first transformed feature of each group of neighbouring points and the second transformed feature is determined as the association relationship between each group of neighbouring points and a corresponding data point.

Interaction processing may be performed on the first transformed feature of each group of neighbouring points and the second transformed feature, e.g., the first transformed feature of each group of neighbouring points is connected with or multiplied by the second transformed feature, to obtain a relationship weight between the two features, and the relationship weight is used as the interaction parameter between the two features.

The above operations S141 to S144 provide a manner of “determining the association relationships between the concatenated point cloud and the plurality of groups of neighbouring points of the concatenated point cloud”, in which the relationships between the neighbouring points in the point cloud is adaptively learned so as to extract key features in the point cloud data.

After the above-mentioned operation S144, linear transformation may be performed on an initial feature of the neighbouring points using another preset value, and the transformed initial feature may be adjusted using the association relationship, to obtain an association feature corresponding to the group of neighbouring points, that is, the above-mentioned operation S201 may be implemented as follows.

In operation S211, linear transformation is performed on a first initial feature of each group of neighbouring points based on a second preset value to obtain a third transformed feature.

There is a multiple relationship between the second preset value and the first preset value. The second preset value and the first preset value have a multiple relationship. For example, the first preset value is n times the second preset value. In a specific example, the first preset value may be set to 64 and the second preset value may be set to 32. Linear processing may be first performed on the first initial feature by using a multi-layer perceptron network, for example, the dimension of the first initial feature is raised; then linear transformation may be performed on the first initial feature after the dimension rise based on the second preset value to obtain the third transformed feature.

In operation S212, an association feature of each data point is determined based on the association relationships and the third transformed feature of each group of neighbouring points.

The third transformed feature of each group of neighbouring points may be enhanced according to the association relationship, and the enhanced feature of each group of neighbouring points may be fused to obtain the association feature corresponding to the group of neighbouring points. Thus, linear transformation may be performed on initial features of a group of neighbouring point by using a second preset value having a multiple relationship with the first preset value. The initial features of the neighbouring points after linear transformation may be enhanced based on the association relationships between the initial feature of each data point and the initial features of the group of neighbouring points, so that the association feature with more details can be obtained.

After the point cloud data is acquired, multiple groups of neighbouring points may be determined by performing first linear transformation on the initial feature of each data point and taking each data point after linear transformation as a center point, which may be implemented as follows.

In a first step, each data point is linearly transformed to obtain each converted data point. The initial feature of each data point may be linearly transformed using a multi-layer perceptron network, and the transformed initial feature is taken as the initial feature of each data point.

In a second step, the multiple groups of neighbouring points for said each converted data point is determined. Multiple groups of neighbouring points may be determined with each converted data point as a center point. That is, before the operation of “performing linear transformation on the first initial feature based on the first preset value to obtain the first transformation feature”, the linear transformation may be performed for each data point. Thus, linear transformation may be performed on the initial feature of each data point, and then the structure relationship inside the point cloud may be adaptively learned in a point cloud self-attention kernel module, so that more effective feature information can be obtained.

The target feature may be updated by adding a residual path to complement the gradient in the target feature extraction process, that is, after operation S202, the method may further include following operations.

In operation S204, linear transformation is performed on the target feature to obtain a core target feature.

In a relationship enhancement network, after a target feature of each data point is determined by using multiple groups of neighbouring points of different scales, the target feature may be linearly transformed using a multi-layer perceptron network to change the dimension of a feature vector in the target feature to obtain a core target feature.

In operation S205, linear transformation is performed on the second initial feature of each data point to obtain a residual feature of the each data point.

In a relationship enhancement network, feature extraction may be first performed on each data point input to obtain a second initial feature; then, a multi-layer perceptron network is used to perform linear transformation on the second initial feature to obtain the residual feature. In this way, the residual point feature may be used as a new residual path, so as to prevent the gradient from disappearing during the complicated processing on the main path.

In operation S206, the target feature is updated based on the residual feature and the core target feature to obtain an updated target feature.

In the relationship enhancement network, the residual feature and the core target feature may be added up element-by-element to further enhance the target feature, i.e., to obtain the updated target feature. Thus, by adding a residual path, the gradient that disappears in the process of performing complicated processing on the initial feature may be supplemented, and the finally obtained updated target feature takes into account not only the original feature information but also the feature information subjected to complicated processing, so that the updated target feature has more details.

A method for training a point cloud completion network is also provided. The point cloud completion network includes a probability generation network and a relationship enhancement network. By adjusting network parameters of a preset probability generation network and a preset relationship enhancement network, an adjusted probability generation network and an adjusted relationship enhancement network can be obtained, thereby obtaining a trained point cloud completion network. The point cloud completion network may be applied to the above-described embodiment for completing the first point cloud to obtain the second point cloud. The process of training the point cloud completion network is as shown in FIG. 2B. FIG. 2B is a schematic diagram of an implementation flow of a method for training a point cloud completion network according to an embodiment of the present disclosure. The following description is made in connection with the operations shown in FIG. 2B.

In operation S271, a first sample point cloud is acquired.

The first sample point cloud may be 3D point cloud data collected for any object or transmitted by other devices. The first sample point cloud includes a sample incomplete point cloud with an incomplete shape and a sample complete point cloud corresponding to the sample incomplete point cloud. For example, the sample incomplete point cloud may be partial point cloud data collected for a desk lamp picture at an angle, and the sample complete point cloud may be all point cloud data of the desk lamp picture that can be collected at the angle.

In operation S272, a sample probability distribution of the first sample point cloud is determined by using a preset probability generation network.

The network architecture of the preset probability generation network includes two paths, i.e., an upper reconstruction path with the complete first sample point cloud as an input, and a lower completion path with the sample incomplete point cloud as an input. The upper reconstruction path is used only to train the preset probability generation network. After the preset probability generation network is completely trained, the first point cloud may be completed through the lower completion path. The first sample point cloud may be input into the preset probability generation network, variational automatic encoding may be performed on the input first sample point cloud in the upper reconstruction path and the lower completion path, respectively, to determine a conditional probability distribution of the first sample point cloud. The upper reconstruction path and the lower completion path of the preset probability generation network may share weights. That is, in the preset probability generation network, the network parameters in the preset probability generation network may be adjusted by both the upper reconstruction path and the lower completion path.

The sample complete point cloud and the sample incomplete point cloud in the first sample point cloud may be encoded by using the variational automatic encoder of the probability generation network, and the encoded point cloud may be performed using a linear residual module, so as to quickly determine the conditional probability distribution of the sample complete point cloud and the sample incomplete point cloud, that is, the above-mentioned operation S272 may be implemented as follows.

In operation S2721, variational encoding is performed on the sample incomplete point cloud through the preset probability generation network, to determine a first probability distribution of the sample incomplete point cloud.

The sample incomplete point cloud may be input to the lower completion path 502 of the preset probability generation network. First, the feature dimension of the input sample incomplete point cloud is converted to 128 using the first shared multi-layer perceptron network; next, a point cloud feature with a feature dimension being 128 is converted into a point cloud feature with a dimension being 256 by using a second shared multi-layer perceptron network; then, a point cloud feature with a dimension being 256 is input to the pooling layer to perform maximum pooling processing; then, element-by-element multiplication is performed between the pooling processing result and the point cloud feature with the dimension being 256; then, the multiplication result is input to a third shared multi-layer perceptron network to convert a point cloud feature with a feature dimension being 256 into a point cloud feature with a dimension being 512; then, the point cloud feature with a feature dimension being 512 is converted into a point cloud feature with a dimension being 1024 using a fourth shared multi-layer perceptron network; finally, a point cloud feature with a dimension being 1024 is input to the pooling layer, and a maximum pooling process is performed to obtain a sample encoded point cloud. The first probability distribution of the sample residual point cloud is obtained by performing residual processing on the sample encoded point cloud.

In operation S2722, variational encoding is performed on the sample complete point cloud through the preset probability generation network, to determine a second probability distribution of the sample complete point cloud.

The sample complete point cloud may be input to the upper reconstruction path of the preset probability generation network, and a plurality of shared multi-layer sensing networks may be used to convert the point cloud feature with a feature dimension being 1024 of the sample complete point cloud; finally, the point cloud feature with the dimension being 1024 may be input to the pooling layer for the maximum pooling processing to obtain the sample encoded point cloud; and the second probability distribution of the sample complete point cloud may be obtained by performing residual processing on the sample encoded point cloud. Thus, in the upper reconstruction path of the preset probability generation network, the variational automatic encoder takes the sample complete point cloud as the input and learns from the sample complete point cloud the conditional probability distribution of generated representation when the input point cloud has a fixed value. Next, the variational automatic encoder may reconstruct the point cloud from the representation of the point cloud and at the same time learn the conditional probability distribution of a generated point cloud when the input representation has a fixed value. The point cloud completion path is also composed of a variational automatic encoder. However, the parameters of the encoder and decoder of this variational automatic encoder are consistent with the parameters in the point cloud reconstruction path. The point cloud completion path takes the incomplete point cloud as input and learns from the incomplete point cloud a conditional probability distribution of generated characterization when the input point cloud has a fixed value. Thus, variational encoding is performed on the sample complete point cloud and the sample incomplete point cloud through the upper reconstruction path and the lower completion path, respectively, to determine the second probability distribution and the first probability distribution, such that the preset probability generation network can learn the conditional probability distribution of the generated representation when the input point cloud has a fixed value, and at the same time can learn the conditional probability distribution of the generated point cloud generated when the input characterization has a fixed value.

In operation S2723, the sample probability distribution is obtained based on the first probability distribution and the second probability distribution.

The first probability distribution and the second probability distribution may be combined to constitute a sample probability distribution of the first sample point cloud.

In operation S273, a complete shape of the first sample point cloud is predicted based on the sample probability distribution to obtain a first predicted point cloud.

The first sample point cloud may be sampled based on the sample probability distribution, and the complete shape of the first sample point cloud may be predicted from the sampled points, thereby obtaining a roughly estimated first predicted point cloud.

The sample incomplete point cloud and the sample complete point cloud may be predicted, respectively, so as to obtain a rough contour of the sample incomplete point cloud and a reconstructed point cloud of the sample complete point cloud, that is, the above-mentioned operation S273 may be implemented as follows.

In operation S2731, the sample incomplete point cloud is completed based on the first probability distribution of the sample probability distribution to obtain the sample primary completed point cloud.

In the lower completion path of the preset probability generation network, sampling may be performed based on the first probability distribution of the sample incomplete point cloud, and the contour of the point cloud may be roughly estimated based on the sample points, so as to generate a rough complete point cloud, i.e., the sample primary complete point cloud. A plurality of linear residual modules may be used to perform residual processing on the point cloud features output by the variational automatic encoder to obtain a conditional probability distribution of the sample residual point cloud; a point cloud feature may be sampled based on the conditional probability distribution, and the sampling result and the point cloud feature output by the variational automatic encoder may be added up element-by-element; the summation result may be input into the fully connected layer to obtain a rough complete point cloud, that is, a sample primary complete point cloud. In this way, the details contained in the input sample incomplete point cloud can be greatly preserved.

In operation S2732, the sample complete point cloud is reconstructed based on the second probability distribution of the sample probability distribution and the first probability distribution to obtain a reconstructed complete point cloud.

The sample complete point cloud may be sampled in comprehensive consideration of the first probability distribution of the sample incomplete point cloud and the second probability distribution of the sample complete point cloud, thereby reconstructing the reconstructed point cloud of the sample complete point cloud, i.e., obtaining the reconstructed complete point cloud. In the upper reconstruction path, the conditional probability distribution obtained from residual processing on the residual point cloud X by a plurality of linear residual modules and the conditional probability distribution obtained from residual processing on the complete point cloud Y by a single linear residual module are added up element-by-element, and the summation result is input to the fully connected layer to obtain the reconstructed point cloud, that is, the reconstructed complete point cloud.

In operation S2733, the sample primary completed point cloud and the reconstructed complete point cloud are determined as the first predicted point cloud.

The sample primary completed point cloud and the reconstructed complete point cloud may be combined together as the first predicted point cloud, and network parameters of the preset probability generation network may be jointly adjusted to obtain a probability generation network capable of accurately predicting the complete contour of the incomplete point cloud.

In the process of training the probability generation network, rough completion is predicted based on embedded global features and learned hidden distributions. The training of the probabilistic generation network is accomplished using a dual-path architecture that includes two parallel paths: an upper reconstruction path for the complete point cloud Y corresponding to the incomplete point cloud and a lower completion path for the incomplete point cloud X. In the process of training the probability generation network, in the upper reconstruction path, the complete point cloud Y corresponding to the incomplete point cloud is first used as an input, so as to learn the probability distribution of features of the point cloud when the input point cloud has a fixed value. Next, the complete point cloud Y is input to the variational automatic encoder, which reconstructs the point cloud according to the features of the complete point cloud Y and simultaneously learns the probability distribution of the generated point cloud when the input representation has a fixed value; the output result of the automatic encoder is input into a single linear residual module to obtain a conditional probability distribution (i.e., a second probability distribution); then, the conditional probability distribution is sampled, the sampling points are added up element-by-element, and the summation result is input to the fully connected layer to obtain the reconstructed point cloud. Meanwhile, in order to train the capability of the network to reconstruct the point cloud, the generated complete point cloud is compared with the input real complete point cloud to obtain a similarity, and this similarity is also taken as part of the loss function.

In the lower completion path, the incomplete point cloud X is used as an input to learn therefrom a probability distribution of generated point cloud features when the input point cloud has a fixed value. In order to make the feature probability distribution learned by the point cloud completion path similar to the feature probability distribution learned by the corresponding point cloud reconstruction path, the KL divergence of the two distributions is added to the trained loss function. The incomplete point cloud X is input into a variational automatic encoder (here, the variational automatic encoder has consistent parameters with the encoder and decoder of the variational automatic encoder); an output result is input to a plurality of linear residual modules to obtain a conditional probability distribution (i.e., a first probability distribution); then, the residual point cloud is sampled according to the conditional probability distribution, and the sample points and the results output by the plurality of linear residual modules are added up element-by-element; and the summation result is input into the fully connected layer to obtain a rough complete point cloud (i.e., a first predicted point cloud).

In operation S274, the first predicted point cloud is adjusted by using a preset relationship enhancement network based on the first sample point cloud to obtain a second predicted point cloud of the first sample point cloud.

The first sample point cloud and the processed first predicted point cloud may be used as inputs into the preset relationship enhancement network. In the preset relationship enhancement network, a structural relationship within the point cloud may be learned by integrating features of local neighbouring points and relationships between neighbouring points, so that key and rich point cloud features of the first sample point cloud can be extracted by adaptively learning relationships between neighbouring points in the point cloud. The preset relationship enhancement network includes three modules: a point cloud self-attention kernel module, a point cloud selective kernel module, and a residual point selective kernel module. Through the three modules, a feature of a global shape of a first sample point cloud may be learned and inferred based on relationships between neighbouring points at a plurality of scales of point clouds, so that a reasonable and real global shape, namely, a second sample point cloud, can be further generated and completed.

In operation S275, a network parameter of the probability generation network is adjusted based on loss of the first predicted point cloud, and a network parameter of the relationship enhancement network is adjusted based on loss of the second predicted point cloud.

After the first predicted point cloud is obtained during training of the preset probability generation network, the loss of the first predicted point cloud may be determined, and the network parameter of the preset probability generation network may be adjusted based on the loss to obtain a probability generation network with the adjusted parameter. In the process of training the network to be trained and enhanced, the loss of the second predicted point cloud may be obtained after the second predicted point cloud is obtained, and the network parameter of the network to be trained and enhanced may be adjusted based on the loss to obtain a relationship enhancement network with the adjusted parameter.

In the process of training the preset probability generation network, loss functions of two paths of the preset probability generation network may be generated based on the similarity between the conditional probability distribution generated by the variational automatic encoder and the Gaussian distribution as well as the similarity between the generated rough complete point cloud and the input real complete point cloud, and a loss function of the preset probability generation network may be obtained based on the loss functions of the two paths. The implementation process is as follows.

In a first step, completion loss is determined based on the similarity between the first probability distribution and the second probability distribution as well as the similarity between the sample primary completed point cloud and the sample completed point cloud. The similarity between the first probability distribution of the sample incomplete point cloud and the second probability distribution of the sample complete point cloud may be determined based on KullbacKLeibler (KL) divergence. The similarity between the sample complete point cloud and the sample primary completed point cloud representing the rough contour of the sample incomplete point cloud and obtained through the lower completion path may be determined based on estimated expectation to obtain the completion loss.

In a second step, first reconstruction loss is determined based on the similarity between the second probability distribution and a preset standard distribution as well as the similarity between the reconstructed complete point cloud and the sample complete point cloud. The similarity between the second probability distribution of the sample complete point cloud and the Gaussian distribution may be determined based on KL divergence; and the similarity between the reconstructed complete point cloud obtained through the upper reconstruction path and the sample complete point cloud may be determined based on estimated expectation to obtain the first reconstruction loss. In this way, in order to make the representational conditional probability distribution learned by the lower completion path and the representational conditional probability distribution learned by the corresponding point cloud reconstruction path similar, the KL divergence of the two conditional probability distributions is added to the training loss function. Meanwhile, the similarity between the generated sample primary complete point cloud and the real sample complete point cloud is added to the training loss function, so that the rough complete point cloud generated by the lower complete path (that is, the sample primary complete point cloud) can be similar to the sample complete point cloud corresponding to the input sample incomplete point cloud.

In a third step, the network parameter of the preset probability generation network is adjusted based on the completion loss and the first reconstruction loss to obtain the adjusted probability generation network.

The completion loss and the first reconstruction loss may be combined to jointly adjust the network parameter of the preset probability generation network, so that the loss function output from the preset probability generation network can meet a convergence condition, thereby obtaining the adjusted probability generation network. Thus, the KL divergence is introduced as a part of the loss function when the preset probability generation network is trained, so that the representational conditional probability distribution generated when the input point cloud has a fixed value is close to the Gaussian distribution. Meanwhile, the capability of the network to reconstruct a point cloud may be trained by comparing the similarity between the generated reconstructed complete point cloud and the input sample complete point cloud and taking the similarity as part of the loss function.

In the first step to the third step, the process of training the preset probability generation network is implemented, so that a rough point cloud with a complete shape, that is, a primary point cloud, can be generated for the input incomplete network based on the adjusted probability generation network.

The process of training the preset relationship enhancement network may includes the operations described below.

In a first step, second reconstruction loss is determined based on the similarity between the second sample point cloud and the sample complete point cloud.

The primary completed point cloud output from the preset probability generation network and the input sample incomplete point cloud may be input to the preset relationship enhancement network, and the input point cloud features may be enhanced by combining the structural relationship between each data point in the point cloud and multiple groups of neighbouring points, thereby obtaining the second sample point cloud with finer features. The similarity between the generated second sample point cloud and the sample complete point cloud may be determined based on the estimated expectation to obtain reconstruction loss of the preset relationship enhancement, i.e., the second reconstruction loss.

In a second step, a network parameter of the preset relationship enhancement network is adjusted based on the second reconstruction loss to obtain the adjusted relationship enhancement network.

The network parameter of the preset relationship enhancement network may be adjusted based on the second reconstruction loss, so that the loss function of the preset relationship enhancement network output can meet the convergence condition, thereby obtaining the adjusted relationship enhancement network. Thus, the primary completed point cloud generated by the probability generation network and the input sample incomplete point cloud may be combined and then input into the input relationship enhancement network; the point cloud selective module in the relationship enhancement network can learn the structural relationship between different scales of point clouds, so that the accuracy of the point cloud completed network is improved.

The first predicted point cloud and the sample incomplete point cloud X may be concatenated and input into the relationship enhancement network to obtain a fine complete point cloud (i.e., a second predicted point cloud). Here, the similarity between the generated point cloud and the real point cloud may be added to the training loss function, so that the rough complete point cloud generated by the point cloud completion path can be similar to the real complete point cloud corresponding to the input incomplete point cloud.

In operation S276, a point cloud completion network is generated based on the probability generation network with the adjusted parameter and the relationship enhancement network with the adjusted parameter.

The output of the adjusted probability generation network may be combined with the first point cloud of the initial input as input to the adjusted relationship enhancement network, to form a point cloud completion network.

In the embodiments of the present disclosure, the process of training the point cloud completion network is implemented through two networks, and a reasonable high-precision point cloud can be generated based on the input incomplete point cloud while the input incomplete point cloud is kept.

Hereinafter, an exemplary implementation in an actual application scenario according to an embodiment of the present disclosure will be described, and an example in which an input point cloud is completed by a variational association point completion network will be described.

Embodiments of the present disclosure provide Variational Relational Point Completion Network (VRCNet), which consists of two consecutive decoder subnetworks for probability generation and relationship enhancement, respectively. A smooth complete shape is used as priori data by the probability generation network to improve the rough completion degree generated by a two-path architecture consisting of two parallel paths: 1) a reconstruction path for a complete point cloud; and 2) a completion path for an incomplete point cloud. According to the embodiments of the present disclosure, in the training process, the consistency between the posterior inference of the encoding of the incomplete point cloud and the prior inference of the complete point cloud is normalized. Based on the overall framework of rough completion generated by the probability generation network, the relationship enhancement network enhances the structural relationship by learning local point cloud features of multiple scales. Embodiments of the present disclosure propose to use a point cloud self-attention kernel module, instead of a fixed weight, as a basic constructing block of the relationship enhancement network. The point cloud self-attention kernel module interleaves local point cloud features by adaptively predicting weights based on association relationships between adjacent point clouds. The embodiments of the present disclosure propose a point selective kernel (PSK) module that utilizes a plurality of branches having different kernel sizes to utilize and fuse point features of multiple scales to further improve the performance of the relationship enhancement network.

In an example, first point cloud data is taken as point cloud data acquired in a game place. For a game played in the game place, a point cloud acquisition device is adopted to acquire pictures of a game table where the game is played, a player, a game coin and the like to acquire a first point cloud. Since a player may look down at a game coin or chat or the like in the game place, it may be difficult to acquire a complete face picture of the player, or the acquired game coin picture may be incomplete due to occlusion by a hand of the player or the like. In such a case, the first point cloud acquired by the single point cloud acquisition device may be incomplete due to occlusion or the like, and it may be difficult to accurately detect a positional relationship between players by the incomplete point cloud data. In the embodiments of the present disclosure, first, a reasonable contour of the first point cloud may be predicted by determining a probability distribution of the first point cloud representing the player picture, thereby obtaining a primary completed point cloud that conforms to the shape of the first point cloud and is reasonable. Then, the obtained primary completed point cloud may be combined with the first point cloud to obtain a concatenated point cloud. A plurality of groups of neighbouring points of different scales may be determined based on the point data in the concatenated point cloud, and the concatenated point cloud may be adjusted based on association relationships between the plurality of groups of neighbouring points and the concatenated point cloud to obtain a second point cloud from completion to the first point cloud of the player picture. In this way, the accuracy of the primary completed point cloud can be improved by combining the structural relationships of multiple groups of neighbouring points of different scales of the concatenated point cloud, so that the second point cloud with high-precision point cloud details can be obtained. Thus, by completing the incomplete first point cloud and enhancing features, the accuracy in detecting the positional relationship between game objects can be improved based on the second point cloud having high-precision details.

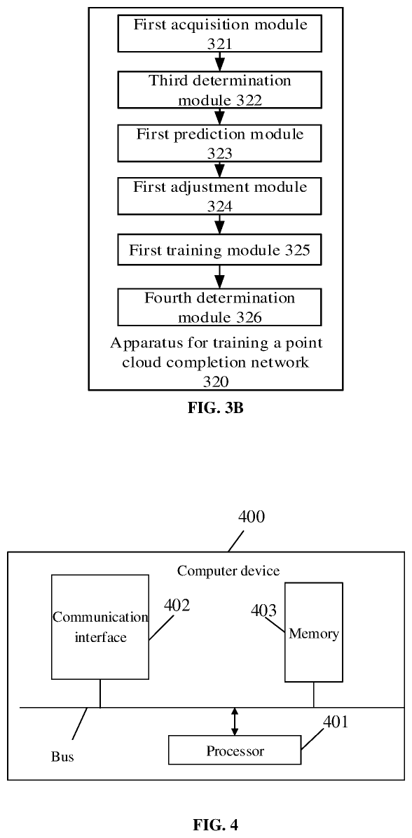

An embodiment of the present disclosure provides an apparatus for point cloud completion. FIG. 3A is a schematic diagram of structure and component of the apparatus for point cloud completion.

As shown in FIG. 3A, the apparatus 300 includes: a first determination module 301 configured to determine a probability distribution of an acquired first point cloud; a first completion module 302 configured to complete the first point cloud based on the probability distribution to obtain a primary completed point cloud; a first concatenation module 303 configured to concatenate the primary completed point cloud and the first point cloud to obtain a concatenated point cloud; a second determination module 304 configured to determine association relationships between the concatenated point cloud and multiple groups of neighbouring points of the concatenated point cloud; and a first adjustment module 305 configured to complete the concatenated point cloud based on the association relationships to obtain a second point cloud from completion to the first point cloud.

The first determination module 301 may include: a first encoding submodule configured to perform variational encoding on the first point cloud to obtain an encoded point cloud; a first processing submodule configured to perform residual processing on the encoded point cloud to obtain a residual point cloud; and a first determination submodule configured to determine the probability distribution based on the residual point cloud.

The first completion module 302 may include: a first prediction submodule configured to predict a first appearance shape of an object to which the first point cloud belongs based on the probability distribution; a second determination submodule configured to determine a second appearance shape of the object represented by the first point cloud, where an integrity of the first appearance shape is greater than an integrity of the second appearance shape; and a first completion submodule configured to complete the second appearance shape based on the first appearance shape to obtain the primary completed point cloud.

The first adjustment module 305 may include: a third determination submodule configured to determine an association feature of each data point in the concatenated point cloud based on association relationships between each data point in the concatenated point cloud and corresponding groups of neighbouring points; a fourth determination submodule configured to determine a target feature of each data point based on the association feature of each data point; and a fifth determination submodule configured to obtain the second point cloud from the completion to the first point cloud based on the target feature of the each data point in the concatenated point cloud.

The third determination submodule may include: a first pooling unit configured to perform average pooling processing on the association features of the each data point corresponding to the groups of neighbouring points to obtain a pooling feature; a second determination unit configured to determine a group association degree between the each data point and each corresponding group of neighbouring points based on the pooling feature; and a third determination unit configured to determine the target feature of the each data point based on the group association degree and the association feature of the each data point.

The second determination unit may include: a first determination subunit configured to determine an association degree between each data point and each neighbouring point in each corresponding group of neighbouring points based on the pooling feature to obtain a set of point association degrees; and a second determination subunit configured to determine a group association degree of the each group of neighbouring points based on the set of point association degrees.

The third determination unit may include: a first adjustment subunit configured to adjust the association feature of the each data point based on the group association degree of each group of neighbouring points to obtain an adjusted association feature corresponding to each group of neighbouring points; and a first fusion subunit configured to fuse the adjusted association features corresponding to the groups of neighbouring points of the each data point to obtain the target feature of the each data point.

The second determination module 304 may include: a sixth determination submodule configured to determine a first initial feature of each group of neighbouring points and a second initial feature of each data point in the concatenated point cloud, respectively; a first transformation submodule configured to perform linear transformation on the first initial feature based on a first preset value to obtain a first transformation feature; a second transformation submodule configured to perform linear transformation on the second initial feature based on the first preset value to obtain a second transformation feature; and a first association submodule configured to determine a relationship parameter between the first transformed feature of each group of neighbouring points and the second transformed feature as an association relationship between the each group of neighbouring points and a corresponding data point.

The third determination submodule may include: a first transformation unit configured to perform linear transformation on a first initial feature of each group of neighbouring points based on a second preset value to obtain a third transformed feature; where there is a multiple relationship between the second preset value and a first preset value; and a third determination unit configured to determine the association feature of the each data point based on the association relationship and the third transformation feature of each group of neighbouring points.

The apparatus may further include: a first transformation module configured to perform linear transformation on the target feature to obtain a core target feature; a second transformation module configured to perform linear transformation on a second initial feature of each data point to obtain a residual feature of each data point; and a first updating module configured to update the target feature based on the residual feature and the core target feature to obtain an updated target feature.

An embodiment of the present disclosure provides an apparatus for training a point cloud completion network. FIG. 3B is a schematic diagram of structure and component of the apparatus.

As shown in FIG. 3B, the apparatus 320 includes: a first acquisition module 321 configured to acquire a first sample point cloud; a third determination module 322 configured to determine a sample probability distribution of the first sample point cloud using a preset probability generation network; a first prediction module 323 configured to predict a complete shape of the first sample point cloud based on the sample probability distribution to obtain a first predicted point cloud; a first adjustment module 324 configured to adjust the first predicted point cloud based on the first sample point cloud by using a preset relationship enhancement network to obtain a second predicted point cloud; a first training module 325 configured to adjust a network parameter of the probability generation network based on loss of the first predicted point cloud, and adjust a network parameter of the relationship enhancement network based on loss of the second predicted point cloud; and a fourth determination module 326 configured to generate a point cloud completion network based on the probability generation network with the adjusted parameter and the relationship enhancement network with the adjusted parameter.

The first sample point cloud may include a sample incomplete point cloud of an incomplete shape and a sample complete point cloud corresponding to the sample incomplete point cloud.

The third determination module 322 may include: a second encoding submodule configured to perform variational encoding on the sample incomplete point cloud through the preset probability generation network to determine a first probability distribution of the sample incomplete point cloud; a third encoding submodule configured to perform variational encoding on the sample complete point cloud through the preset probability generation network to determine a second probability distribution of the sample complete point cloud; and a seventh determination submodule configured to obtain the sample probability distribution based on the first probability distribution and the second probability distribution.

The first prediction module 323 may include: a second completion submodule configured to complete the sample incomplete point cloud based on a first probability distribution of the sample probability distribution to obtain a sample primary completed point cloud; a first reconstruction submodule configured to reconstruct the sample complete point cloud based on a second probability distribution of the sample probability distribution and the first probability distribution to obtain a reconstructed complete point cloud; and an eighth determination submodule configured to determine the sample primary completed point cloud and the reconstructed complete point cloud as the first predicted point cloud.

The first training module 325 may include: a ninth determination submodule configured to determine completion loss based on a similarity between the first probability distribution and the second probability distribution and a similarity between the sample primary completed point cloud and the sample complete point cloud; a tenth determination submodule configured to determine first reconstruction loss based on a similarity between the second probability distribution and a preset standard distribution as well as a similarity between the reconstructed complete point cloud and the sample complete point cloud; and a first adjustment submodule configured to adjust the network parameter of the probability generation network based on the completion loss and the first reconstruction loss to obtain the probability generation network with the adjusted parameter.

The first training module 325 may include: an eleventh determination submodule configured to determine second reconstruction loss based on the similarity between the second predicted point cloud and the sample complete point cloud; and a first training submodule configured to adjust the network parameter of the relationship enhancement network based on the second reconstruction loss to obtain the relationship enhancement network with the adjusted parameter.

It should be noted that the above description of the apparatus embodiments is similar to that of the method embodiments, and has similar advantages to those of the method embodiments. For technical details not described in the apparatus embodiments, reference is made to the description of the method embodiments of the present disclosure.

It should be noted that, when the method for point cloud completion described above is implemented in the form of a software function module and sold or used as a stand-alone product, the method for point cloud completion may also be stored in a computer readable storage medium. Based on such an understanding, the technical solution the present disclosure, in essence or in part contributing to the prior art, may be embodied in the form of a software product stored in a storage medium including instructions causing a computer device (which may be a terminal, a server, or the like) to implement all or part of the methods described in the present disclosure. The storage medium includes a USB flash drive, a moving hard disk, a Read Only Memory (ROM), a magnetic disk, or an optical disk. The embodiments are not limited to any particular combination of hardware and software.

Accordingly, a computer program product is provided, which includes computer-executable instructions that, when executed, can implement the operations of the method for point cloud completion.

Accordingly, a computer storage medium is provided, which has stored thereon computer-executable instructions that, when executed by a processor, can implement the operations of the method for point cloud completion.

Accordingly, a computer device is provided. FIG. 4 is a schematic structural diagram of the computer device according to an embodiment. As shown in FIG. 4, the device 400 includes a processor 401, at least one communication bus, a communication interface 402, at least one external communication interface, and a memory 403. The communication interface 402 is configured to implement connection communication between these components. The communication interface 402 may include a display screen, and the external communication interface may include standard wired and wireless interfaces. The processor 401 is configured to execute the picture processing program in the memory to implement the operations of the method for point cloud completion.

The above description of embodiments of the apparatus for point cloud completion, the computer device, and the storage medium is similar to that of the above method embodiments, and has technical advantages similar to those of the corresponding method embodiments, which will not be repeated here. Reference can be made to the description of the above method embodiments. For technical details not described in the embodiments of the apparatus for point cloud completion, computer apparatus and storage medium, reference can be made to the description of the method embodiments.

It is to be understood that reference throughout the specification to “one embodiment” or “an embodiment” means that a particular feature, structure, or feature associated with the embodiment is included in at least one embodiment of the present disclosure. Thus, “in one embodiment” or “in an embodiment” throughout the specification are not necessarily directed to a same embodiment. Furthermore, these specific features, structures, or features may be combined in any suitable manner in one or more embodiments. It is to be understood that, the magnitude of the sequence numbers of the processes described above does not mean the order of execution. The order of execution may be determined by their function and intrinsic logic, and should not be construed as any limitation on the implementation of the embodiments. The above embodiment are for description only and do not represent the advantages or disadvantages of the embodiments. It is to be noted that the terms “comprises” “comprising” or any other variation thereof are intended to cover a non-exclusive inclusion, such that a process, method, article or apparatus that comprises a list of elements includes not only those elements but also other elements not expressly listed, or includes elements inherent to such process, method, article or apparatus. Without more limitations, it is not excluded that the process, method, article or apparatus including an element defined by the statement “comprise a . . . ” further includes another same element.

It is to be understood that the disclosed apparatuses and methods may be implemented in other ways. The apparatus embodiments are merely illustrative, for example, the unit partitioning is only one logical function partitioning and may be implemented in another partitioning manner, e.g., a plurality of units or components may be combined, or may be integrated into another system, or some features may be ignored, or not performed. In addition, coupling, or direct coupling, or communication connection of the components shown or discussed may be indirect coupling, or communication connection through some interfaces, devices, or units, and may be electrical, mechanical, or in other forms.

The units described above as separate parts may be or may not be physically separate. The units may be or may not be physical units. The units may be located at one location or distributed across a plurality of network elements. Some or all of elements may be selected based on actual needs to achieve the objectives of the embodiments.

In addition, various functional units in embodiments may be integrated into a single processing unit, or each unit may be a separate single unit, or two or more units may be integrated into a single unit. The integrated unit may be implemented by hardware or by hardware plus software functional units. It will be appreciated by persons skilled in the art that all or a portion of the operations of the above method embodiments may be carried out by hardware associated with program instructions. The above program may be stored in a computer readable storage medium. The program, when executed, may perform the operations of the above method embodiments. The storage medium includes a removable storage device, a Read Only Memory (ROM), a magnetic disk, or an optical disk.

Alternatively, the integrated unit described above may be stored in a computer readable storage medium if implemented as a software functional module and sold or used as a separate product. Based on such an understanding, the technical solution of the embodiments, in essence or in part contributing to the prior art, may be embodied as a software product stored in a storage medium including instructions for causing a computer device (which may be a personal computer, a server, a network device, or the like) to perform all or part of the methods described above. The above-mentioned storage medium includes various media in which program codes can be stored, such as a removable storage device, a ROM, a magnetic disk, or an optical disk. The foregoing description is merely illustrative of embodiments, but the scope of protection is not limited thereto. Variations or substitutions may readily occur to those skilled in the art within the technical scope as disclosed, and are intended to be included within the scope of protection of the present disclosure. Accordingly, the scope of protection should be subject to the scope of protection of the claims.

1. A method for point cloud completion, comprising:
determining a probability distribution of an acquired first point cloud;
completing the first point cloud based on the probability distribution to obtain a primary completed point cloud;
concatenating the primary completed point cloud and the first point cloud to obtain a concatenated point cloud;
determining association relationships between the concatenated point cloud and multiple groups of neighbouring points of the concatenated point cloud; and
completing the concatenated point cloud based on the association relationships to obtain a second point cloud from completion to the first point cloud.

2. The method of claim 1, wherein the determining a probability distribution of the acquired first point cloud comprises:
performing variational encoding on the first point cloud to obtain an encoded point cloud;
performing residual processing on the encoded point cloud to obtain a residual point cloud; and
determining the probability distribution based on the residual point cloud.

3. The method of claim 1, wherein the completing the first point cloud based on the probability distribution to obtain a primary completed point cloud comprises:
predicting a first appearance shape of an object to which the first point cloud belongs based on the probability distribution;
determining a second appearance shape of the object represented by the first point cloud, wherein an integrity of the first appearance shape is greater than an integrity of the second appearance shape; and
completing the second appearance shape based on the first appearance shape to obtain the primary completed point cloud.

4. The method of claim 1, wherein the completing the concatenated point cloud based on the association relationships to obtain a second point cloud from completion to the first point cloud comprises:
determining an association feature of each data point in the concatenated point cloud based on association relationships between the each data point in the concatenated point cloud and corresponding groups of neighbouring points;
determining a target feature of the each data point based on the association feature of the each data point; and
obtaining the second point cloud from the completion to the first point cloud based on the target feature of the each data point in the concatenated point cloud.

5. The method of claim 4, wherein the determining a target feature of the each data point based on the association feature of the each data point comprises:
performing average pooling processing on the association feature of the each data point corresponding to the groups of neighbouring points to obtain a pooling feature;
determining a group association degree between the each data point and each corresponding group of neighbouring points based on the pooling feature; and
determining the target feature of the each data point based on the group association degree and the association feature of the each data point.

6. The method of claim 5, wherein the determining a group association degree between the each data point and each corresponding group of neighbouring points based on the pooling feature comprises:
determining an association degree between each data point and each neighbouring point in the each corresponding group of neighbouring points based on the pooling feature to obtain a set of point association degrees; and
determining a group association degree of the each group of neighbouring points based on the set of point association degrees.

7. The method of claim 5, wherein the determining the target feature of the each data point based on the group association degree and the association feature of the each data point comprises:
adjusting the association feature of the each data point based on the group association degree of the each group of neighbouring points to obtain an adjusted association feature corresponding to the each group of neighbouring points; and
fusing the adjusted association features corresponding to the groups of neighbouring points of the each data point to obtain the target feature of the each data point.

8. The method of claim 1, wherein the determining association relationships between the concatenated point cloud and multiple groups of neighbouring points of the concatenated point cloud comprises:
determining a first initial feature of each group of neighbouring points and a second initial feature of each data point in the concatenated point cloud, respectively;
performing linear transformation on the first initial feature based on a first preset value to obtain a first transformed feature;
performing linear transformation on the second initial feature based on the first preset value to obtain a second transformed feature; and
determining a relationship parameter between the first transformed feature of the each group of neighbouring points and the second transformed feature as an association relationship between the each group of neighbouring points and a corresponding data point.

9. The method of claim 4, wherein the determining an association feature of each data point in the concatenated point cloud based on association relationships between the each data point in the concatenated point cloud and corresponding groups of neighbouring points comprises:
performing linear transformation on a first initial feature of each group of neighbouring points based on a second preset value to obtain a third transformed feature, wherein there is a multiple relationship between the second preset value and a first preset value; and
determining the association feature of the each data point based on the association relationships and the third transformed feature of the each group of neighbouring points.

10. The method of claim 5, wherein after the determining the target feature of the each data point based on the association feature of the each data point, the method further comprises:
performing linear transformation on the target feature to obtain a core target feature;
performing linear transformation on a second initial feature of the each data point to obtain a residual feature of the each data point; and
updating the target feature based on the residual feature and the core target feature to obtain an updated target feature.

11. An apparatus for point cloud completion, comprising:
a processor; and
a memory storing instructions executable by the processor,
wherein the processor, when executing the instructions, implements operations comprising:
determining a probability distribution of an acquired first point cloud;
completing the first point cloud based on the probability distribution to obtain a primary completed point cloud;
concatenating the primary completed point cloud and the first point cloud to obtain a concatenated point cloud;
determining association relationships between the concatenated point cloud and multiple groups of neighbouring points of the concatenated point cloud; and
completing the concatenated point cloud based on the association relationships to obtain a second point cloud from completion to the first point cloud.

12. The apparatus of claim 11, wherein the processor is configured to:
perform variational encoding on the first point cloud to obtain an encoded point cloud;
perform residual processing on the encoded point cloud to obtain a residual point cloud; and
determine the probability distribution based on the residual point cloud.

13. The apparatus of claim 11, wherein the processor is configured to:
predict a first appearance shape of an object to which the first point cloud belongs based on the probability distribution;
determine a second appearance shape of the object represented by the first point cloud, wherein an integrity of the first appearance shape is greater than an integrity of the second appearance shape; and
complete the second appearance shape based on the first appearance shape to obtain the primary completed point cloud.

14. The apparatus of claim 11, wherein the processor is configured to:
determine an association feature of each data point in the concatenated point cloud based on association relationships between the each data point in the concatenated point cloud and corresponding groups of neighbouring points;
determine a target feature of the each data point based on the association feature of the each data point; and
obtain the second point cloud from the completion to the first point cloud based on the target feature of the each data point in the concatenated point cloud.

15. The apparatus of claim 14, wherein the processor is configured to:
perform average pooling processing on the association feature of the each data point corresponding to the groups of neighbouring points to obtain a pooling feature;
determine a group association degree between the each data point and each corresponding group of neighbouring points based on the pooling feature; and
determine the target feature of the each data point based on the group association degree and the association feature of the each data point.

16. The apparatus of claim 15, wherein the processor is configured to:
determine an association degree between each data point and each neighbouring point in the each corresponding group of neighbouring points based on the pooling feature to obtain a set of point association degrees; and
determine a group association degree of the each group of neighbouring points based on the set of point association degrees.

17. The apparatus of claim 15, wherein the processor is configured to:
adjust the association feature of the each data point based on the group association degree of the each group of neighbouring points to obtain an adjusted association feature corresponding to the each group of neighbouring points; and
fuse the adjusted association features corresponding to the groups of neighbouring points of the each data point to obtain the target feature of the each data point.

18. The apparatus of claim 11, wherein the processor is configured to:
determine a first initial feature of each group of neighbouring points and a second initial feature of each data point in the concatenated point cloud, respectively;
perform linear transformation on the first initial feature based on a first preset value to obtain a first transformed feature;
perform linear transformation on the second initial feature based on the first preset value to obtain a second transformed feature; and
determine a relationship parameter between the first transformed feature of the each group of neighbouring points and the second transformed feature as an association relationship between the each group of neighbouring points and a corresponding data point.

19. The apparatus of claim 14, wherein the processor is configured to:
perform linear transformation on a first initial feature of each group of neighbouring points based on a second preset value to obtain a third transformed feature, wherein there is a multiple relationship between the second preset value and a first preset value; and
determine the association feature of the each data point based on the association relationships and the third transformed feature of the each group of neighbouring points.

20. A non-transitory computer storage medium having stored thereon computer-executable instructions, wherein the computer-executable instructions, when executed, are capable of implementing operations of the method of claim 1.
